(19) United States
(12) Patent Application Publication
(10) Pub. No.: US 2009/0057960 A1
(43) Pub. Date: Mar. 5, 2009

(54) RESIN MOLD AND PROCESS FOR PRODUCING A MOLDED ARTICLE USING THE MOLD

(75) Inventor: Motofumi Kashiwagi, Yokosuka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Zeon Corporation, Tokyo (JP)

(21) Appl. No.: 11/910,203

(22) PCT Filed: Sep. 29, 2005
(86) PCT No.: PCT/JP2005/018508

§ 371 Date: Sep. 28, 2007

(30) Foreign Application Priority Data
Mar. 30, 2005 (JP) 2005-098432

(51) Int. Cl. B29C 35/08; H05B 6/00

(52) U.S. Cl. 264/488; 425/174.4

(57) ABSTRACT

A resin mold used for replicating a pattern of protrusions and depressions to a molded article in the photo nano imprint lithography for producing a molded article having a pattern of protrusions and depressions on the surface, which comprises a mold material comprising at least one resin selected from thermoplastic resins having a nonpolar alicyclic structure and thermoplastic resins having an alicyclic structure having a halogen atom; and a process for producing a molded article having a pattern of protrusions and depressions on the surface, which comprises replicating the pattern to a layer for replication disposed on a substrate using the resin mold described above in accordance with the photo nano imprint lithography. The resin mold is used for producing a molded article having a pattern of protrusions and depressions of the nanometer level on the surface and exhibits excellent property of releasing the molded article from the mold.

### TECHNICAL FIELD

The present invention relates to a resin mold used in the photo nano imprint lithography and a process for producing a molded article using the mold. More particularly, the present invention relates to a resin mold used for producing a molded article having a pattern of protrusions and depressions of the nanometer level on the surface, which is used in the fields of semiconductors and flat panel displays, in accordance with the photo nano imprint lithography and exhibiting the excellent property of releasing the molded article from the mold, and a process for producing the molded article with excellent productivity by replicating a pattern of protrusions and depressions in accordance with the photo nano imprint lithography using the resin mold.

### BACKGROUND ART

Heretofore, the photolithography has been used as the technology for fine working in the fields of semiconductors and flat panel displays. In the photolithography, the surface of a substrate such as a silicon wafer, a glass substrate and a support which is, for example, a resin film or a metal foil, is coated with a photosensitive resist composition in accordance with a suitable process such as the spraying process, the roll coating process and the rotation coating process. Then, the formed coating layer pattern of protrusions and depressions to the resist. The thickness of the entire resist layer to which the pattern of protrusions and depressions has been replicated is decreased using oxygen plasma so that the substrate having the layer for replication is exposed and, thereafter, the dry etching is conducted to replicate the pattern of protrusions and depressions. A molded article having a pattern of protrusions and depressions on the surface can be obtained as described above (the thermal nano imprint lithography). The original plate recovered by the peeling can be used repeatedly.

It is studied recently that a molded article having a pattern of protrusions and depressions on the surface is obtained by application of the photo nano imprint lithography, in which quartz is used for the original plate, the original plate is pressed to a substrate having a layer for replication coated with a photocurable resin in place of a resist, the photocurable resin is cured by irradiation with ultraviolet light at the upper face of the original plate to replicate the pattern of protrusions and depressions of the original plate, and the original plate is peeled off.

The photo nano imprint lithography has an advantage in that decreases in the accuracy of the positions due to thermal expansion of the original plate and the substrate for the replication do not take place unlike the thermal nano imprint lithography since the operations are conducted at the room temperature.

However, when quartz is used for the original plate, the releasing property in peeling the original plate from the cured product of the photocurable resin is poor, and problems arise in that durability of the original plate decreases, and the pattern of protrusions and depressions formed by the replication shows damages.

[Patent Reference 1] U.S. Pat. No. 5,772,905

[Patent Reference 2] Japanese Patent Application Laid Open No. 2000-232095

### DISCLOSURE OF THE INVENTION

Under the above circumstances, the present invention has an object of providing a mold used for producing a molded article having a pattern of protrusions and depressions of the nanometer level on the surface, which is used in the fields of semiconductors and flat panel displays, in accordance with the photo nano imprint lithography and exhibiting the excellent property of releasing the molded article from the mold, and a process for producing the molded article with excellent productivity by replication of a pattern of protrusions and depressions in accordance with the photo nano imprint lithography using the resin mold.

As the result of extensive studies by the present inventors to achieve the above object, it was found that the object could be achieved by using a mold material comprising a thermoplastic resin having a nonpolar alicyclic structure or a thermoplastic resin having an alicyclic structure having a halogen atom as the material of the mold for the photo nano imprint lithography, and that an excellent molded article could be obtained without decrease in the property for replication in the reuse of the resin mold by bringing fluorine gas into contact with the surface of the resin mold using the above mold material.

The present invention provides:

(1) A resin mold used for replicating a pattern of protrusions and depressions to a molded article in photo nano imprint lithography for producing a molded article having a pattern of protrusions and depressions on a surface, which comprises a mold material comprising at least one resin selected from thermoplastic resins having a nonpolar alicyclic structure and thermoplastic resins having an alicyclic structure having a halogen atom;
(2) The resin mold described in (1), wherein a transmittance of light of the mold material is 90% or greater in a range of a wavelength of 300 to 500 nm;
(3) The resin mold described in any one of (1) and (2), wherein at least one resin selected from thermoplastic resins having a nonpolar alicyclic structure and thermoplastic resins having an alicyclic structure having a halogen atom is a hydrogenation product of a ring-opening (copolymer of a cyclic olefin monomer;
(4) A process for producing a molded article having a pattern of protrusions and depressions on a surface, which comprises replicating a pattern of protrusions and depressions to a layer for replication disposed on a substrate using the resin mold described in any one of (1) to (3) in accordance with photo nano imprint lithography;
(5) A process for producing a molded article having a pattern of protrusions and depressions on a surface, which comprises pressing the resin mold described in any one of (1) to (3) to a layer of a photocurable resin material disposed on a substrate as a layer for replication, curing the layer of a photocurable resin material by irradiation with an active ray at a side of the resin mold, and peeling the resin mold from the produced molded article;
(6) A resin mold which is obtained by bringing fluorine gas into contact with a surface of the resin mold described in any one of (1) to (3);
(7) The process for producing a molded article described in any one of (4) and (5), wherein the resin mold described in (6) is used as the resin mold; and
(8) A process for producing a molded article having a pattern of protrusions and depressions on a surface, which comprises, in the process described in (5), pressing the resin mold peeled from the molded article to a layer of a photocurable resin material disposed on a substrate, curing the layer of a photocurable resin material by irradiation with an active ray at a side of the resin mold, and peeling the resin mold from the produced molded article.

### BRIEF DESCRIPTION OF THE DRAWINGS

FIG. 1 shows a process diagram exhibiting an example of the process for producing a molded article of the present invention. In the FIGURE, the mark 1 means a substrate, the marks 2, 2a and 2b each mean a layer of a photocurable resin material, the mark 3 means a resin mold, and the mark 10 means a molded article.

### THE MOST PREFERRED EMBODIMENT TO CARRY OUT THE INVENTION

The resin mold of the present invention will be described in the following.

The resin mold of the present invention comprises a mold material comprising at least one resin selected from thermoplastic resins having a nonpolar alicyclic structure and thermoplastic resins having an alicyclic structure having a halogen atom and is used for replicating a pattern of protrusions and depressions to a molded article in the photo nano imprint lithography for producing a molded article having a pattern of protrusions and depressions on the surface.

As the material constituting the mold material, a thermoplastic resin having a nonpolar alicyclic structure and/or a thermoplastic resin having an alicyclic structure having a halogen is used in the present invention.

“Nonpolar” means “having no polar groups in the molecule”. The polar group is a group of atoms containing an atom having lone pair electrons and divided into protonic polar groups and polar groups other than the protonic polar groups (nonprotonic polar groups).

The protonic polar group is a group in which hydrogen atom is directly bonded to a heteroatom, which is specifically an atom of the second or the third period in Group 15 or Group 16 of the Periodic Table.

Examples of the protonic polar group include polar groups having oxygen atom such as carboxyl group (hydroxycarbonyl group), sulfonic acid group, phosphoric acid group and hydroxyl group; polar groups having nitrogen atom such as primary amino groups, secondary amino groups, primary amido groups and secondary amido groups (imido groups); and polar groups having sulfur atom such as thiol group.

Examples of the nonprotonic polar group include groups having an ester group (meaning both of alkoxycarbonyl groups and aryloxycarbonyl groups), an N-substituted imido group, epoxy group, cyano group, carbonyloxycarbonyl group (the acid anhydride residue group of a dicarboxylic acid), an alkoxyl group, carbonyl group, a tertiary amino group, sulfonic group or an acryloyl group.

Although halogen atoms are, in general, regarded as nonprotonic polar groups, thermoplastic resins having an alicyclic structure having a halogen atom can be used in the present invention.

The thermoplastic resin having a nonpolar alicyclic structure and the thermoplastic resin having an alicyclic structure having a halogen atom used in the present invention is a polymer having a structural unit derived from a cyclic olefin monomer such as the norbornene structural unit and may further have structural units derived from monomers other than the cyclic olefin monomer. The thermoplastic resin having an alicyclic structure includes ring-opening (co)polymers of cyclic olefin monomers, addition copolymers of cyclic olefins and vinyl alicyclic hydrocarbon monomers or vinyl aromatic hydrocarbon monomers and hydrogenation products thereof. In the present invention, the thermoplastic resin having an alicyclic structure is a concept including homopolymers and copolymers of vinyl alicyclic hydrocarbon monomers (alicyclic hydrocarbons having vinyl group as a substituent), copolymers with other monomers, hydrogenation products thereof and hydrogenation products of (co)polymers of vinyl aromatic hydrocarbon monomers and copolymers with other monomers. The polymer may be any of a ring-opening polymer and an addition polymer. Among the above polymers, ring-opening (co)polymers of cyclic olefin monomers, hydrogenation products thereof, addition copolymers of cyclic olefin monomers and vinyl alicyclic hydrocarbon monomers or vinyl aromatic hydrocarbon monomers, hydrogenation products thereof and hydrogenation products of polymers of vinyl aromatic hydrocarbon monomers are preferable, and hydrogenation products of ring-opening (co)polymers of cyclic olefin monomers are more preferable.

Examples of the cyclic olefin monomer for obtaining the thermoplastic resin having a nonpolar alicyclic structure include cyclic olefin monomers having no polar groups described above. Specific examples of the cyclic olefin monomer include bicyclo[2.2.1]hept-2-ene (ordinarily called norbornene), 2-ethylbicyclo[2.2.1]hept-2-ene, 5-butylbicyclo[2.2.1]hept-2-ene, 5-ethylidenebicyclo[2.2.1]hept-2-ene, 5-methylidenebicyclo[2.2.1]hept-2-ene, 5-vinylbicyclo[2.2.1]hept-2-ene, tricyclo[4.3.0.1^{2,5}]deca-3.7-diene (ordinarily called dicyclopentadiene), tetracyclo[8.4.0.1^{11,14}.0^{3,7}]pentadeca-3,5,7,12,11-pentaene, tetracyclo-[4.4.0.1^{2,5}.1^{7,10}]deca-3-ene (ordinarily called tetracyclododecene), 8-methyltetracyclo[4.4.0.1^{2,5}.1^{7,10}]dodeca-3-ene, 8-ethyltetracyclo[4.4.0.1^{2,5}.1^{7,10}]dodeca-3-ene, 8-methylidenetetracyclo[4.4.0.1^{2,5}.1^{7,10}]dodeca-3-ene, 8-ethylidenetetracyclo[4.4.0.1^{2.5}.1^{7,10}]dodeca-3-ene, 8-vinyltetracyclo-[4.4.0.1^{2,5}.1^{7,10}]dodeca-3-ene, 8-propenyltetracyclo[4.4.0.1^{2,5}.1^{7,10}]dodeca-3-ene, pentacyclo[6.5.1.1^{3,6}.0^{2,7},0^{9,13}]pentadeca-3,10-diene, cyclopentene, cyclopentadiene, 1,4-methano-1,4,4a,5,10,10a-hexahydroanthracene, 8-phenyltetracyclo[4.4.0.1^{2,5}.1^{7,10}]dodeca-3-ene, tetracyclo[9.2.1.0^{2,10}.O^{3.8}]-tetradeca-3,5,7,12-tetraene (also called 1,4-methano-1,4,4a,9a-tetrahydro-9H-fluorene), pentacyclo[7.4.0.1^{3,6}.1^{10,13}.0^{2,7}]pentadeca-4,11-diene and pentacyclo[9.2.1.1^{4,7}.0^{2,10},0^{3,8}]pentadeca-5,12-diene.

Examples of the cyclic olefin monomer for obtaining the thermoplastic resin having an alicyclic structure having a halogen include cyclic olefin monomers having a halogen atom. Specific examples of the cyclic olefin monomer having a halogen atom include 8-chlorotetracyclo-[4.4.0.1^{2,5}.1^{7,10}]dodeca-3-ene and 8-methyl-8-chlorotetracyclo[4.4.0.1^{2,5}.1^{7,10}]dodeca-3-ene.

In the present invention, the cyclic olefin monomer having no polar groups and the cyclic olefin monomer having a halogen atom may be used singly or in combination of two or more. Among the above monomers, norbornene is preferable.

Examples of the vinyl alicyclic hydrocarbon monomer include vinylcycloalkanes such as vinylcyclopropane, vinylcyclobutane, vinyl-cyclopentane, vinylcyclohexane and vinylcycloheptane; and vinyl-cycloalkanes substituted with an alkyl group such as 3-methyl-1-vinylcyclohexane, 4-methyl-1-vinylcyclohexane, 1-phenyl-2-vinylcyclopropane and 1,1-diphenyl-2-vinylcyclopropane.

Examples of the vinyl aromatic hydrocarbon monomer include vinyl aromatic compounds such as styrene, 1-vinylnaphthalene, 2-vinyl-naphthalene and 3-vinylnaphthalene; vinyl aromatic compounds substituted with an alkyl group such as 3-methylstyrene, 4-propylstyrene, 4-cyclohexylstyrene, 4-dodecylstyrene, 2-ethyl-4-benzylstyrene and 4-(phenylbutyl)styrene; and polyfunctional vinyl aromatic compounds such as m-divinylbenzene, p-divinylbenzene and bis(4-vinylphenyl)-methane.

Typical examples of the monomer copolymerizable with the cyclic olefin other than the monomers described above include chain-form olefins. Examples of the chain-form olefin include α-olefins having 2 to 20 carbon atoms such as ethylene, propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene and 1-eicosene; and non-conjugated dienes such as 1,4-hexadiene, 4-methyl-1,4-hexadiene, 5-methyl-1,4-hexadiene and 1,7-octadiene. These monomers can be used singly or in combination of two or more.

The above monomer can be polymerized in accordance with a conventional process. For example, the ring-opening polymerization or the addition polymerization can be conducted.

As the polymerization catalyst, for example, complexes of metals such as molybdenum, ruthenium and osmium can be used. The polymerization catalyst may be used singly or in combination of two or more. The amount of the polymerization catalyst as expressed by the ratio of the amount by mole of the metal compound in the polymerization catalyst to the amount by mole of the cyclic olefin monomer is, in general, in the range of 1:100 to 1:2,000,000, preferably in the range of 1:500 to 1:1,000,000 and more preferably in the range of 1:1,000 to 1:500,000.

The cyclic olefin resin obtained above by the polymerization may be hydrogenated, where necessary.

The hydrogenation is conducted, in general, using a hydrogenation catalyst. As the hydrogenation catalyst, for example, catalysts conventionally used for hydrogenation of olefin compounds can be used. Specifically, homogeneous catalysts of the Ziegler type, noble metal complex catalysts and supported noble metal-based catalysts can be used. Among these hydrogenation catalysts, noble metal complex catalysts such as rhodium catalysts and ruthenium catalysts are preferable, and ruthenium catalysts in which a heterocyclic carbene compound having nitrogen or a phosphine exhibiting an excellent electron donating property is coordinated are more preferable.

The weight-average molecular weight (Mw) of the thermoplastic resin having an alicyclic structure is, in general, in the range of 1,000 to 1,000,000, preferably in the range of 1,500 to 100,000 and more preferably in the range of 2,000 to 10,000.

The molecular weight distribution expressed as the ratio of the weight-average molecular weight to the number-average molecular weight (Mw/Mn) is, in general, 4 or smaller, preferably 3 or smaller and more preferably 2.5 or smaller.

The weight-average molecular weight (Mw) and the number-average molecular weight (Mn) described above are the values obtained by the measurement in accordance with the gel permeation chromatography (GPC) using cyclohexane (or toluene) as the solvent and expressed as the corresponding values of polyisoprene (polystyrene when toluene is used as the solvent).

The glass transition temperature (Tg) of the thermoplastic resin having an alicyclic structure used in the present invention can be suitably selected in accordance with the application. The glass transition temperature is, in general, in the range of 50 to 400° C., preferably in the range of 70 to 350° C. and more preferably in the range of 90 to 300° C. The obtained resin mold exhibits excellent durability and workability in molding when Tg of the resin is in the above range.

The melt flow rate (measured in accordance with the method of Japanese Industrial Standard K 7210 except that the temperature of the measurement is 280° C. and the load of the measurement is 21.18 N) of the thermoplastic resin having an alicyclic structure is, in general, 1 to 100 g/10 minutes, preferably 2 to 70 g/10 minutes and more preferably 3 to 50 g/10 minutes from the standpoint of workability in molding for obtaining the resin mold having a pattern of fine protrusions and depressions.

The mold material used for the resin mold of the present invention may further comprise various additive components in combination with the thermoplastic resin having an alicyclic structure, where desired. Examples of the additive component include mold releases, other polymers, antioxidants, heat stabilizers, light stabilizers, ultraviolet light absorbents, lubricants, antistatic agents, dyes, coloring agents, antiblocking agents, natural oils, synthetic oils, waxes, flame retardants, auxiliary flame retardants, compatibilizers, crosslinking agents, auxiliary crosslinking agents and plasticizers.

The mold release is used for further improving the releasing property between the resin mold and the cured product of the photocurable resin material. The mold release is not particularly limited. In general, compounds which have a long chain hydrocarbon group and a small number of polar groups and form a lubricating layer with some portions of the compounds migrating to the surface of the molded article since the polar portion exhibits suppressed compatibility while the overall structure exhibits good compatibility with the thermoplastic resin having an alicyclic structure, are used.

Examples of the above compound include fatty acids, derivatives of fatty acids such as fatty acid amides, fatty acid esters, fatty acid ketones and aliphatic alcohols; and derivatives of polyhydric alcohols such as ester compounds and partial ester compounds of fatty acids and polyhydric alcohols and partial ether compounds of polyhydric alcohols. Among these compounds, fatty acid esters such as stearyl stearate, trialkyl trimellitates and n-butyl stearate; ester compounds of fatty acids and polyhydric alcohols such as 12-hydroxystearic acid triglyceride; partial ester compounds of fatty acids and polyhydric alcohols such as behenic acid monoglyceride, stearic acid monoglyceride, pentaerythritol distearate, pentaerythritol monostearate and polyglycerol stearic acid esters; and partial ether compounds of polyhydric alcohols such as polyglycerol nonylphenyl ether, are preferable, and stearyl stearate, behenic acid monoglyceride, 12-hydroxystearic acid triglyceride, trialkyl trimellitate (C9), pentaerythritol distearate and polyglycerol nonylphenyl ether are more preferable.

The amount of the mold release is, in general, 0.01 to 10 parts by weight, preferably 0.05 to 5 parts by weight and more preferably 0.1 to 3 parts by weight per 100 parts by weight of the thermoplastic resin having an alicyclic structure from the standpoint of the balance between the releasing property and the mechanical strength of the resin mold.

Examples of the other polymer include “soft polymer” and “other resins”. In general, “soft polymer” means a polymer having a glass transition temperature (Tg) of 30° C. or lower. In the case of a polymer having a plurality of Tg or both of Tg and the melting point (Tm), the polymer is included in the soft polymer when the lowest Tg is 30° C. or lower.

Examples of the soft polymer include (a) olefin-based soft polymers derived mainly from α-olefins such as ethylene and propylene, (b) isobutylene-based soft polymers derived mainly from isobutylene, (c) diene-based soft polymers derived mainly from conjugated dienes such as butadiene and isoprene, (d) soft polymers having the silicon-oxygen bond as the skeleton structure (organic polysiloxanes), (e) soft polymers derived mainly from α,β-unsaturated acids and derivatives thereof, (f) soft polymers derived mainly from unsaturated alcohols and amines, acyl derivatives of amines or acetals, (g) polymers of epoxy compounds, (h) fluorine-based rubbers, and (i) other soft polymers.

Examples of soft polymer (a) described above include liquid polyethylene, atactic polypropylene and homopolymers of 1-butene, 4-methyl-1-butene, 1-hexene, 1-octene and 1-decene; and copolymers such as ethylene-α-olefin copolymers, propylene-α-olefin copolymers, ethylene-propylene-diene copolymers (EPDM), ethylene-cyclic olefin copolymers and ethylene-propylene-styrene copolymers.

Examples of soft polymer (b) include polyisobutylene, isobutylene-isoprene rubber and isobutylene-styrene copolymers.

Examples of soft polymer (c) include homopolymers of conjugated dienes such as polybutadiene and polyisoprene; random copolymers of conjugated dienes such as butadiene-styrene random copolymers, isoprene-styrene random copolymers, acrylonitrile-butadiene copolymers, hydrogenation products of acrylonitrile-butadiene copolymers and acrylonitrile-butadiene-styrene copolymers; block copolymers of conjugated dienes and aromatic vinyl-based hydrocarbons such as butadiene-styrene block copolymers, styrene-butadiene-styrene block copolymers, isoprene-styrene block copolymers and styrene-isoprene-styrene block copolymers; and hydrogenation products of these polymers.

Examples of soft polymer (d) include silicone rubbers such as dimethylpolysiloxane, diphenylpolysiloxane and dihydroxypolysiloxane.

Examples of soft polymer (e) include homopolymers of acrylic monomers such as polybutyl acrylate, polybutyl methacrylate, polyhydroxyethyl methacrylate, polyacrylamide and polyacrylonitrile; and copolymers of acrylic monomers and other monomers such as butyl acrylate-styrene copolymers.

Examples of soft polymer (f) include homopolymers of (esterified) unsaturated alcohols such as polyvinyl alcohol, polyvinyl acetate, polyvinyl stearate, polyvinyl benzoate and polyvinyl maleate; and copolymers of (esterified) unsaturated alcohols and other monomers such as vinyl acetate-styrene copolymers.

Examples of soft polymer (g) include polyethylene oxide, polypropylene oxide and epichlorohydrin rubber.

Examples of soft polymer (h) include vinylidene fluoride-based rubber and tetrafluoroethylene-propylene rubber.

Examples of soft polymer (i) include natural rubber, polypeptides, proteins, polyester-based thermoplastic elastomers described in Japanese Patent Application Laid-Open No. Heisei 8(1996)-73709, vinyl chloride-based thermoplastic elastomers and polyamide-based thermoplastic elastomers.

The soft polymer may have a crosslinked structure or may have functional groups introduced by modification.

In the present invention, from the standpoint of preventing decrease in transparency of the obtained resin mold, soft polymers (a), (b) and (c) are preferable among the above polymers due to the excellent elasticity, mechanical strength, flexibility and mixing property. Among these polymers, soft polymer (c), the diene-based soft polymer, is more preferable, and hydrogenation products of the diene-based soft polymer obtained by hydrogenation of the carbon-carbon unsaturated bond in the conjugated diene bonding unit are most preferable. Examples of the soft polymer described above include hydrogenation products of homopolymers such as polybutadiene, hydrogenation products of random copolymers such as butadiene-styrene copolymers, and hydrogenation products of block copolymers such as butadiene-styrene block copolymers, styrene-butadiene-styrene block copolymers, isoprene-styrene block copolymers and styrene-isoprene-styrene block copolymers.

The “other resin” is a resin having no protonic polar groups other than the resins described above. Examples of the other resin include chain-form polyolefins such as low density polyethylene, high density polyethylene, linear low density polyethylene, ultralow density polyethylene, polypropylene, syndiotactic polypropylene, polybutene and polypentene; polyesters such as polyethylene terephthalate and polybutylene terephthalate; polyamides such as nylon 6 and nylon 66; ethylene-ethyl acrylate copolymers; ethylene-vinyl acetate copolymers; polyamides; polyesters; polycarbonates; polyimides; and epoxy resins.

In the present invention, the other polymers described above may be used singly or in combination of two or more. The amount of the other polymer is, in general, 100 parts by weight or less, preferably 70 parts by weight or less and more preferably 50 parts by weight or less per 100 parts by weight of the thermoplastic resin having an alicyclic structure. The lower limit of the amount is 0 part by weight.

It is preferable that the antioxidants, the heat stabilizers, the light stabilizers and the ultraviolet light absorbents are used among the above additive components since the heat stability and the light stability are improved when the resin mold is repeatedly used.

The process for preparation of the mold material is not particularly limited. For example, after the various additive components are dissolved in a suitable solvent and added to a solution of the thermoplastic resin having an alicyclic structure, the solvent is removed to obtain the thermoplastic resin having an alicyclic structure containing the additive components, or the thermoplastic resin having an alicyclic structure is made melted using a mixer, a twin-screw mixer, rolls, a Bravendor or an extruder and mixed with the additive components.

The resin mold of the present invention comprises the mold material described above and is used as the mold for replicating a pattern of protrusions and depressions to the surface of a molded article in accordance with the photo nano imprint lithography. The resin mold has on the surface thereof a pattern of fine protrusions and depressions for the replication. As the material for the molded article to which the pattern of protrusions and depressions is replicated, a layer of a photocurable resin material disposed on a substrate is used.

Therefore, it is preferable that the mold material used for the resin mold has a transmittance of light of 90% or greater in the entire range of the wavelength of 300 to 500 nm at the portion having the maximum thickness. When the above transmittance is 90% or greater, the layer of a photocurable resin material can be easily cured by irradiation with ultraviolet light through the resin mold.

The transmittance of light of the mold material in the range of the wavelength of 300 to 500 nm is the total light transmittance (%) measured in accordance with the method of Japanese Industrial Standard K 7361-1 using a turbidimeter “NH-300A” (a commercial name) manufactured by NIPPON DENSHOKU KOGYO Co., Ltd.

The resin mold of the present invention can be prepared by molding the above mold material in accordance with a molding process such as the injection molding, the press molding, the injection-blow molding, the multilayer blow molding, the connection blow molding, the double wall blow molding, the stretching blow molding and the vacuum molding. Among the above molding processes, the injection molding and the press molding are preferable since the in-plane fluctuation of the pattern of protrusions and depressions can be decreased.

As the injection molding, for example, the process in which the injection molding is conducted using a mold having a plurality of gates and a stamper which has a pattern of fine protrusions and depressions and is disposed on one face of the cavity, can be used. As the press molding, for example, the process in which a sheet or a film prepared in accordance with the melt extrusion process is heated in a mold having a cavity having the desired shape under pressure, can be used.

When fluorine gas is brought into contact with the resin mold of the present invention, the process is not particularly limited. The process in which the resin mold is left standing in an atmosphere containing fluorine gas is preferable as the convenient process.

For example, the resin mold is disposed in a chamber equipped with a heating apparatus for controlling the temperature at the inside, a line for supplying a gas and a line for discharge. The atmosphere of the air in the chamber is replaced with the atmosphere of fluorine gas by introducing fluorine gas into the chamber through the line for supplying a gas and discharging the air in the chamber through the line for discharge. The atmosphere of fluorine gas has, in general, a concentration of fluorine gas of 10 to 100% by volume based on the inner volume of the chamber, and the replacement can be achieved by introducing fluorine gas into the chamber until the volume of the gas discharge from the line for discharge is, in general, 1 to 5 time the inner volume of the chamber.

Then, the inside of the chamber is heated by the heating apparatus. The temperature at the inside of the chamber is, in general, 60 to 200° C. and preferably 80 to 150° C. It is preferable that the temperature is set at a value not exceeding the above range with consideration on the glass transition temperature and the softening temperature of the thermoplastic resin constituting the resin mold since there is the possibility of deformation of the resin mold at an excessively high temperature. The time of heating is, in general, 1 to 360 minutes, preferably 10 to 360 minutes and more preferably 30 to 300 minutes.

The resin mold which has been brought into contact with fluorine gas on the surface thereof has the advantage in that not only the excellent property for replication of a pattern having fine protrusions and depressions to the layer of a photocurable resin material is exhibited, but also residues of the photocuring resin are not attached to the surface of the face of replication of the resin mold when the same resin mold is used repeatedly due to the excellent property of releasing the mold from the layer of the photocurable resin material. When the same resin mold is used repeatedly, fluorine gas may be brought into contact with the surface of the resin mold before the repeated use.

The process for producing a molded article of the present invention will be described in the following.

The process for producing a molded article having a pattern of protrusions and depressions on a surface of the present invention comprises replicating a pattern of protrusions and depressions to a layer for replication disposed on a substrate using the resin mold described above in accordance with photo nano imprint lithography. Specifically, the resin mold is pressed to the layer of a photocurable resin material disposed on a substrate as the layer for replication, and an active ray is applied at the side of the resin mold to cure the layer of a photocurable resin material. The resin mold is peeled from the molded article, and the pattern of protrusions and depressions is replicated to the surface of the molded article.

In the present invention, the photocurable resin material used for forming the layer of a photocurable resin material is not particularly limited. For example, photocurable resin materials comprising photopolymerizable prepolymers and/or photopolymerizable monomers can be used.

Examples of the photopolymerizable prepolymer include polyester acrylate-based prepolymers, epoxyacrylate-based prepolymers, urethane acrylate-based prepolymers and polyol acrylate-based prepolymers. The polyester acrylate-based prepolymer can be obtained, for example, by obtaining a polyester oligomer having hydroxyl groups at both ends by condensation of a polybasic carboxylic acid with a polyhydric alcohol, followed by esterification of the hydroxyl groups in the obtained oligomer with (meth)acrylic acid; or by obtaining an oligomer having hydroxyl groups at both ends by addition of an alkylene oxide to a polybasic carboxylic acid, followed by esterification of the hydroxyl groups of the obtained oligomer with (meth)acrylic acid. The epoxyacrylate-based prepolymer can be obtained, for example, by esterification of oxirane rings in an epoxy resin of a bisphenol type or a novolak type having a relatively low molecular weight by the reaction with (meth)acrylic acid. The urethane acrylate-based prepolymer can be obtained, for example, by obtaining a polyurethane oligomer by the reaction of a polyether polyol or a polyester polyol with a polyisocyanate, followed by esterification of the obtained oligomer with (meth)acrylic acid. The polyol acrylate-based prepolymer can be obtained, for example, by esterification of hydroxyl groups in a polyether polyol with (meth)acrylic acid. The above photopolymerizable prepolymer may be used singly or in combination of two or more.

As the photopolymerizable monomer, monofunctional photopolymerizable monomers having a single photopolymerizable group in the molecule and polyfunctional photopolymerizable monomers having two or more photopolymerizable group in the molecule can be used. Examples of the photopolymerizable group include vinyl group, allyl group, methallyl group, acryloyl group and methacryloyl group. Among these monomers, photopolymerizable monomers having acryloyl group or methacryloyl group are preferable due to the excellent heat resistance, transparency, weatherability and curing property.

Examples of the monofunctional photopolymerizable monomer include methyl acrylate methyl methacrylate (hereinafter, “(meth)acrylate” means “acrylate and/or methacrylate”), ethyl (meth)acrylate, propyl(meth)acrylate, n-butyl(meth)acrylate, isobutyl (meth)acrylate, decyl(meth)acrylate, isodecyl(meth)acrylate, n-nonyl (meth)acrylate, cyclohexyl(meth)acrylate, lauryl(meth)acrylate, stearyl (meth)acrylate, phenyl(meth)acrylate, benzyl(meth)acrylate, dicyclopentadienyl(meth)acrylate, dicyclopentenoxyethyl(meth)acrylate, 2-dicyclopentenoxyethyl(meth)acrylate, tricyclodecanyl(meth)acrylate, isobornyl(meth)acrylate, methoxyethyl(meth)acrylate, ethoxyethyl (meth)acrylate, butoxyethyl(meth)acrylate, methoxyethoxyethyl (meth)acrylate, ethoxyethoxyethyl(meth)acrylate, phenoxyethyl (meth)acrylate, phenoxypropyl(meth)acrylate, tetrahydrofurfuryl (meth)acrylate, 2-hydroxyethyl(meth)acrylate, 2-hydroxypropyl (meth)acrylate, 4-hydroxybutyl(meth)acrylate, acrylic acid methacrylic acid, acryloylmorpholine and methacryloylmorpholine.

Examples of the polyfunctional photopolymerizable monomer include ethylene glycol di(meth)acrylate, 1,3-propylene glycol-di(meth)acrylate, 1,4-heptanediol di(meth)acrylate, 1,6-hexanediol di(meth)acrylate, diethylene glycol di(meth)acrylate, neopentyl glycol di(meth)acrylate, tetraethylene glycol di(meth)acrylate, 2-butyne 1,4-di(meth)acrylate, cyclohexane-1,4-dimethanol di(meth)acrylate, hydrogenated bisphenol A di(meth)acrylate, 1,5-pentane di(meth)acrylate, trimethylolethane di(meth)acrylate, tricyclodecanyl di(meth)acrylate, trimethylolpropane di(meth)acrylate, dipropylene glycol di(meth)acrylate, 1,3-butylene glycol di(meth)acrylate, 2,2-bis(4-(meth)acryloxypropoxy-phenyl)propane, 2,2-bis(4-(meth)acryloxy(2-hydroxypropoxy)phenyl)-propane, 2,2-bis(4-(meth)acryloyloxyethyl) phthalate, trimethylolpropane tri(meth)acrylate, pentaerythritol tri(meth)acrylate, pentaerythritol tetra(meth)acrylate, dipentaerythritol tri(meth)acrylate, dipentaerythritol tetra(meth)acrylate, dipentaerythritol penta(meth)acrylate, dipentaerythritol hexa(meth)acrylate, tripentaerythritol tetra(meth)acrylate, tripentaerythritol penta(meth)acrylate, tripentaerythritol hexa(meth)-acrylate and tripentaerythritol octa(meth)acrylate.

The photopolymerizable monomer having one or more acryloyl groups or one or more acryloyl groups in the molecule may be used singly or in combination of two or more.

Examples of the photopolymerizable monomer having a photopolymerizable group which is not either acryloyl group or methacryloyl group include styrene, derivatives of styrene such as α-methylstyrene, p-t-butylstyrene and vinyltoluene, unsaturated carboxylic acids such as itaconic acid, maleic acid and fumaric acid, polymerizable unsaturated nitriles such as (meth)acrylonitrile, esters of unsaturated carboxylic acids such as diethyl maleate, dibutyl maleate, dibutyl fumarate, diethyl itaconate and dibutyl itaconate, and vinyl esters such as vinyl acetate and vinyl propionate.

In the photocurable resin material, one or more types of the photopolymerizable prepolymer described above alone, one or more types of the photopolymerizable monomer described above alone or a combination of one or more types of the photopolymerizable prepolymer described above and one or more types of the photopolymerizable monomer described above may be used as the photopolymerizable component.

The photocurable resin material may comprise a photopolymerization initiator, where necessary.

Examples of the photopolymerization initiator include carbonyl compounds such as benzoin, benzoin monomethyl ether, benzoin isopropyl ether, acetoin, benzophenone, p-methoxybenzophenone, diethoxyacetophenone, benzyl dimethyl ketal, 2,2-diethoxyacetophenone, 1-hydroxycyclohexyl phenyl ketone, methyl phenyl glyoxylate, ethyl phenyl glyoxylate, 2-hydroxy-2-methyl-1-phenylpropane-1-one and 2-ethylanthraquinone; sulfur compounds such as tetramethylthiuram monosulfide; and acylphosphine oxides such as 2,6-dimethylbenzoyl-diphenylphosphine oxide and 2,4,6-trimethylbenzoylphenylphosphine oxide.

The photopolymerization initiator may be used singly or in combination of two or more. The amount of the photopolymerization initiator can be suitably selected in accordance with the object of the use. The amount is, in general, 0.001 to 10 parts by weight, preferably 0.005 to 5 parts by weight and more preferably 0.01 to 1 part by weight per 100 parts by weight of the photopolymerizable prepolymer and/or the photopolymerizable monomer.

The photocurable resin material can be prepared as a coating material by dissolving or dispersing the photopolymerizable prepolymer and/or the photopolymerizable monomer described above and the photopolymerization initiator and various additives such as antioxidants, light stabilizers, leveling agents and defoaming agents, which are used where desired, in respective prescribed amounts in a suitable solvent, where necessary.

Examples of the solvent used above include aliphatic hydrocarbons such as hexane, heptane and cyclohexane, aromatic hydrocarbons such as toluene and xylene, halogenated hydrocarbons such as methylene chloride and ethylene chloride, alcohols such as methanol, ethanol, propanol and butanol, ketones such as acetone, methyl ethyl ketone, 2-pentanone and isophorone, esters such as ethyl acetate and butyl acetate, and cellosolve-based solvents such as ethylcellosolve.

The concentration and the viscosity of the coating fluid prepared as described above are not particularly limited as long as the concentration and the viscosity allow the coating operation and can be suitably selected in accordance with the situation.

In the process for producing a molded article of the present invention, the coating fluid comprising the above photocurable resin material is applied to a semiconductor wafer such as a silicon wafer or a substrate such as a member for the preparation of a TFT array substrate in accordance with a conventional process, and the formed coating layer is dried to form a layer of the photocurable resin material. The thickness of the layer of the photocurable resin material is, in general, 0.1 to 5 μm and preferably 0.5 to 2 μm. Then, the resin mold having the prescribed pattern of fine protrusions and depressions of the present invention is pressed to the layer of the photocurable resin material in a manner such that the pattern is faced to the surface of the layer. While the resin mold is kept being pressed to the layer of the photocurable resin material, an active ray is applied at the side of the resin mold. As the active ray, ultraviolet light having a wavelength of 200 to 400 nm is preferable. The irradiation is conducted so that the integrated energy is preferably about 0.1 to 200 J/cm². Examples of the light source used above include fluorescent lights, chemical lamps, metal halide lamps, high pressure mercury lamps and low pressure mercury lamps. The irradiation with the active ray may be conducted in the atmosphere of the air or an inert gas such as nitrogen gas and argon gas.

After the radical polymerization is conducted by irradiation with the active ray as described above, the cured product can be heated to fully complete the curing, where desired. The polymerization can be completed and strains at the inside formed during the polymerization can be decreased by the heating. The temperature of the heating can be suitably selected in accordance with the composition and the glass transition temperature of the cured product. A temperature around the glass transition temperature or lower is preferable since heating at an excessively high temperature causes deterioration in the hue of the cured product.

After the curing is completed by irradiation with the active ray, a molded article having a pattern of fine protrusions and depressions (a pattern of protrusions and depressions as the reversal of the pattern of the resin mold) on the substrate can be obtained by peeling the resin mold from the molded article. In the present invention, since the thermoplastic resin having a nonpolar alicyclic structure or the thermoplastic resin having an alicyclic structure having a halogen is used for the resin mold, the releasing property in peeling the resin mold from the molded article is very excellent, and the accuracy of replication of the pattern of fine protrusions and depressions to the surface of the molded article is excellent. The releasing property can be further improved and the reuse of the resin mold can be facilitated by bringing the resin mold into contact with fluorine gas, as described above.

The curing may be conducted by irradiation with electron beams in place of the active ray. In this case, it is not necessary that the photopolymerization initiator is comprised.

The molded article having the pattern of fine protrusions and depressions on the substrate prepared as described above is, in general, subjected to the treatment for completely removing portions of the layer of the photocurable resin material having a small thickness at depressions in the pattern of protrusions and depressions in accordance with the reactive ion etching process using oxygen (the oxygen RIE process) to expose the substrate.

In the process of the present invention, the limit of the accuracy of replication of the pattern of fine protrusions and depressions formed on the surface of a molded article is, for example, 40 to 80 nm in the case of a line & space pattern.

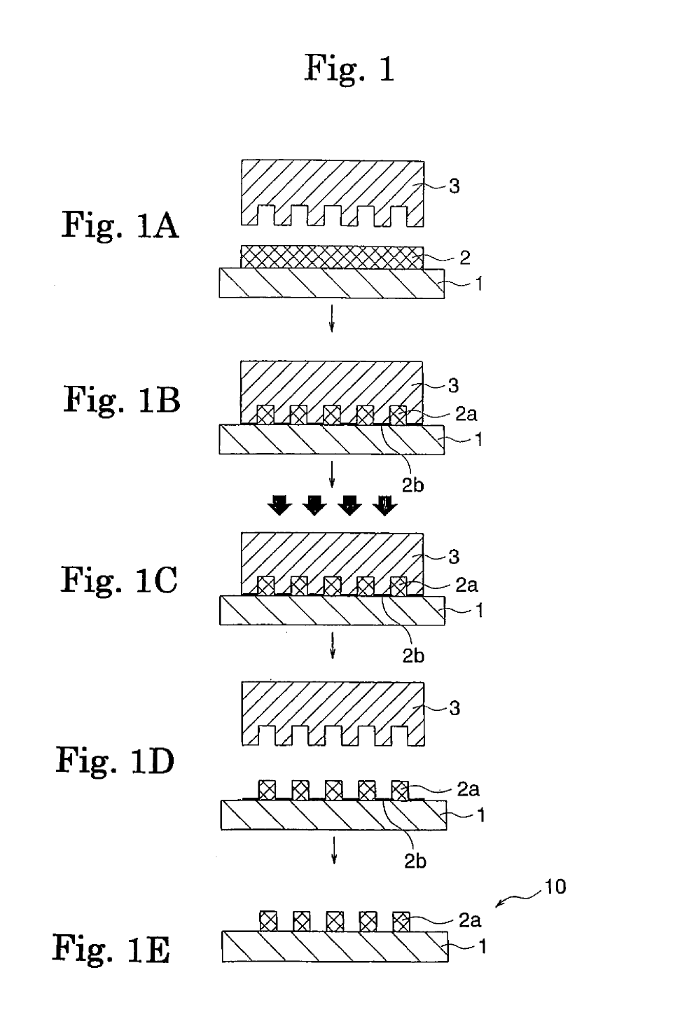

FIG. 1 shows a process diagram exhibiting an example of the process for producing a molded article of the present invention.

At first, a resin mold having a pattern of fine protrusions and depressions on the surface and a substrate 1 having a layer of a photocurable resin material 2 used for replication on the surface are supplied (FIG. 1A). Then, the resin mold 3 is pressed to the layer of a photocurable resin material 2 in a manner such that the pattern of fine protrusions and depressions is faced to the layer of a photocurable resin material (FIG. 1B). The mark 2a means portions of the layer of a photocurable resin material pressed into depressions of the pattern of fine protrusions and depressions of the resin mold 3, and 2b means portions of the layer of a photocurable resin material placed between protrusions of the pattern of fine protrusions and depressions of the resin mold 3 and the substrate.

The layers 2a and 2b of the photocurable resin material are irradiated with an active ray such as ultraviolet light at the side of the resin mold 3, and the layers 2a and 2b of the photocurable resin material are cured (FIG. 1C). The resin mold 3 is peeled off, and a molded article having a pattern of fine protrusions and depressions 2a and 2b on the substrate 1 is obtained (FIG. 1D). As the last step, portions having a small thickness 2b of the layer of the photocurable resin material in the pattern of fine protrusions and depressions is completely removed in accordance with the oxygen RIE process or the like to expose the substrate 1, and a molded article of the object product 10 can be obtained (FIG. 1E).

The resin mold and the process for producing a molded article of the present invention can be advantageously applied to the field of semiconductors, the field of flat panel displays and the fields of biosensors and biochips.

### EXAMPLES

The present invention will be described more specifically with reference to examples in the following. However, the present invention is not limited to the examples.

### Example 1

Using “ZEONEX (a registered trade mark) 480R” [manufactured by ZEON CORPORATION] as the thermoplastic resin having an alicyclic structure, resin molds having line & space patterns of 3 μm, 2.5 μm, 2 μm, 1.5 μm and 1 μm were prepared. The maximum thickness of the obtained resin molds was 100 μm, and the total light transmittance at the portion of the maximum thickness was 92%.

Using each resin mold having a prescribed pattern, the following procedures were conducted.

A silicon wafer was used as the substrate. The substrate was coated with an acrylic resist “PAK-01” [a trade name, manufactured by TOYO GOSEI KOGYO Co., Ltd.] which was a photocuring resin material in accordance with the spin coating process, and a resist film having a thickness of 0.5 μm was formed.

To the layer of the photocuring resin material, the resin mold prepared above was pressed in a manner such that the pattern of protrusions and depressions was faced to the layer of the photocuring resin material. While the resin mold was kept being pressed to the layer of the photocuring resin material, ultraviolet light in an amount of irradiation of 300 mJ/cm² was applied at the side of the resin mold, and the layer of the photocurable resin material was cured. Then, the resin mold was peeled off. The shape of the pattern formed by the replication was observed, and residues at the portions of protrusions and depressions of the resin mold were examined.

As the result, all patterns including the line & space pattern of 1 μm could be replicated, and no residues were found at the portions of protrusions and depressions of the resin mold.

### Example 2

The same resin molds as those obtained in Example 1 were placed in a high pressure chamber, and fluorine gas was introduced into the chamber. When the volume of the gas discharged through a line for discharge reached twice the inner volume of the chamber, the temperature of the chamber was set at 100° C. After the temperature was kept at 100° C. for 2 hours, the resin molds were taken out of the chamber and cooled to the room temperature, and resin molds which had been brought into contact with fluorine gas (hereinafter, referred to as fluorine-treated resin molds) were obtained. In accordance with the same procedures as those conducted in Example 1 except that the fluorine-treated resin molds prepared above were used, patterns of protrusions and depressions were replicated to layers of the photocurable resin material, and the results were evaluated. As the result, all patterns including the line & space pattern of 1 μm could be replicated, and no residues were found at the portions of protrusions and depressions of the fluorine-treated resin molds obtained after the replication of the patterns (hereinafter, referred to as fluorine-treated resin molds used once).

### Example 3

Patterns of protrusions and depressions were replicated to layers of the photocurable resin material in accordance with the same procedures as those conducted in Example 1 except that the fluorine-treated resin molds used once obtained in Example 2 were used, and the results were evaluated. As the result, all patterns including the line & space pattern of 1 μm could be replicated, and no residues were found at the portions of protrusions and depressions of the fluorine-treated resin mold used once.

### Example 4

Fluorine-retreated resin molds were obtained by bringing the fluorine-treated resin molds used once into contact with fluorine gas in accordance with the same procedures as those conducted in Example 2. Patterns of protrusions and depressions were replicated to layers of the photocurable resin material in accordance with the same procedures as those conducted in Example 1 except that the fluorine-retreated resin molds obtained above was used, and the results were evaluated. As the result, all patterns including the line & space pattern of 1 μm could be replicated, and no residues were found at the portions of protrusions and depressions of the resin mold.

### Comparative Example 1

Quartz molds having line & space patterns of the same sizes as those of the resin molds used in Example 1 were prepared by forming resist patterns on quartz substrates in accordance with the photolithography, followed by the etching treatment using a fluorine-based etching fluid.

Thereafter, the same procedures as those conducted in Example 1 were conducted except that the quartz molds obtained above were used in place of the resin molds.

As the result, portions of the line & space pattern of 1.5 μm were missing, and residues of the resist material were found at portions of depressions of the quartz molds.

### Comparative Example 2

The same procedures as those conducted in Example 1 were conducted except that resin molds were prepared using “ARTON (a registered trade name) FX4726” [manufactured by JSR Corporation; a thermoplastic resin having a polar alicyclic structure] in place of “ZEONEX (a registered trade mark) 480R” [manufactured by ZEON CORPORATION].

As the result, more than a half of the line & space pattern of 1 μm was missing, and residues of the resist material were found at portions of depressions of the resin molds.

### INDUSTRIAL APPLICABILITY

The resin mold of the present invention is used for preparing a molded article having protrusions and depressions of the nanometer level on the surface in accordance with the photo nano imprint lithography and exhibits the very excellent property of releasing the mold from the molded article. The above molded article can be produced with excellent productivity by using the resin mold. The molded article can be used in the fields of semiconductor and flat panel displays.

1. A resin mold used for replicating a pattern of protrusions and depressions to a molded article in photo nano imprint lithography for producing a molded article having a pattern of protrusions and depressions on a surface, which comprises a mold material comprising at least one resin selected from thermoplastic resins having a nonpolar alicyclic structure and thermoplastic resins having an alicyclic structure having a halogen atom.

2. The resin mold according to claim 1, wherein a transmittance of light of the mold material is 90% or greater in a range of a wavelength of 300 to 500 nm.

3. The resin mold according to claim 1, wherein at least one resin selected from thermoplastic resins having a nonpolar alicyclic structure and thermoplastic resins having an alicyclic structure having a halogen atom is a hydrogenation product of a ring-opening (co)polymer of a cyclic olefin monomer.

4. A process for producing a molded article having a pattern of protrusions and depressions on a surface, which comprises replicating a pattern of protrusions and depressions to a layer for replication disposed on a substrate using the resin mold described in claim 1 in accordance with photo nano imprint lithography.

5. A process for producing a molded article having a pattern of protrusions and depressions on a surface, which comprises pressing the resin mold described in claim 1 to a layer of a photocurable resin material disposed on a substrate as a layer for replication, curing the layer of a photocurable resin material by irradiation with an active ray at a side of the resin mold, and peeling the resin mold from the produced molded article.

6. A resin mold which is obtained by bringing fluorine gas into contact with a surface of the resin mold described in claim 1.

7. The process for producing a molded article according to any claim 4, wherein a resin mold which is obtained by bringing fluorine gas into contact with a surface of the resin mold is used as the resin mold.

8. A process for producing a molded article having a pattern of protrusions and depressions on a surface, which comprises, in the process described in claim 5, pressing the resin mold peeled from the molded article to a layer of a photocurable resin material disposed on a substrate, curing the layer of a photocurable resin material by irradiation with an active ray at a side of the resin mold, and peeling the resin mold from the produced molded article.

9. The process for producing a molded article according to claim 5, wherein a resin mold which is obtained by bringing fluorine gas into contact with a surface of the resin mold is used as the resin mold.
